(19) United States
(12) Patent Application Publication
(10) Pub. No.: US 2011/0029340 A1
(43) Pub. Date: Feb. 3, 2011

(54) SYSTEM AND METHOD FOR CALCULATING THE ENVIRONMENTAL SAVINGS ASSOCIATED WITH ENVIRONMENTAL PRINTING METHODOLOGIES

(76) Inventors: David Peter Podmayersky, Maywood, NJ (US); Brandon David Podmayersky, Maywood, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/840,794

(22) Filed: Jul. 21, 2010

Related U.S. Application Data
(60) Provisional application No. 61/229,294, filed on Jul. 29, 2009.

(51) Int. Cl. G06Q 99/00

(52) U.S. Cl. 705/7

(57) ABSTRACT

The present invention relates to a system and method for calculating environmental savings achievable as a result of using environmentally friendly paper and environmental printing methodologies when completing a printing job. The system and method receives information describing the characteristics of a given printing job. This information, is used as the basis to calculate one or more environmental savings. The environmental savings could include, but are not limited to, number of trees saved, amount of water saved, amount of energy saved, number of household equivalent power saved, amount of carbon emissions saved, number of automobile equivalent carbon emissions saved, and number of acres saved.

### CROSS-REFERENCE TO RELATED APPLICATION

This application claims the benefit of U.S. Provisional Patent Application No. 61/229,294, filed Jul. 29, 2009, titled, “System and Method for Calculating Environmental Savings Associated with Environmental Printing Methodologies,” which is herein incorporated by reference.

### FIELD OF THE INVENTION

The present invention relates to a system and method for calculating environmental savings generated as a result of utilizing environmentally friendly techniques during the printed product manufacturing process.

### BACKGROUND OF THE INVENTION

Over the past decades, consumers have become increasingly aware of their effect on the environment. With this increased awareness, many households and businesses have begun to seek methods to, minimize their adverse environmental impact. These methods include increasing the use of renewable energy, buying local products, increasing recycling efforts, and monitoring energy consumption.

One sector with significant adverse environmental impact is the paper production and printing industry. The use of paper and printed material in both residential and commercial settings creates a substantial negative impact on the environment. From the harvesting of trees to the use of energy to transform harvested trees into paper, the production of paper creates significant adverse environmental impact. In addition, the use of chemicals to complete printing jobs only adds to the adverse environmental impact of the paper industry.

Despite this need, the prior art lacks a method for aggregating information indicative of the environmental impact related to such activities. Without an efficient method of gathering and analyzing this data, consumers are unable to intelligently assess the environmental result of their printing jobs. A consumer may be aware of the amount of energy required to produce a ream of paper and print text or graphics on the paper. However, without understanding all of the environmental resources utilized to produce the ream of paper and associated printing processes; consumers can not fully understand the true environmental impact of such activities.

Therefore, there is a need in the art for a system and method for aggregating and analyzing information related to the environmental impact of paper purchases and printing. In addition, the prior art lacks a method a convey such information as to allow consumers of printed material to more easily understand how their paper purchase and use may effect the environment and what possible steps could be taken to minimize such impact.

### SUMMARY OF THE INVENTION

Embodiments of the present invention satisfy these needs and others by providing a system and method for calculating the environmental savings achievable as a result of using environmentally friendly paper and environmental printing methodologies when completing a printing job. The term ‘environmental printing methodologies’ is intended to include, but is not limited to, printing processes that focus on reducing a printing processes' environmental impact. Examples of environmental printing methodologies may include, but are not limited to, recycling of post-industrial waste and the use of renewable energy in a printing plant.

Through the use of environmentally friendly paper and environmental printing methodologies, environmental savings can be calculated for a given printing job. The term ‘environmental savings’ is intended to include, but is not limited to, the reduced amount of resources expended to complete a printing job by implementing environmental printing methodologies as compared to completing the same printing job without implementing environmental printing methodologies. This could include reducing the use of trees, energy, and water within the process of completing a printing job. Environmental savings could also include a reduction in harmful outputs produced as a result of a printing job, such as the emissions of carbon dioxide, other greenhouse gases, or volatile organic compounds (VOCs).

According to an embodiment of the present invention, the system and method of the present invention receives a request from a user to complete a printing job. The request may be transmitted by the user through use of electronic communications (e.g., web browser or email). The request may be in the form of an input dataset, wherein the input dataset specifies the characteristics of the printing job. The input dataset may include, but is not limited to, paper height, paper weight, number of papers in each item being printed, number of items being printed, percentage of recycled content in the paper, whether the paper is coated or uncoated, whether the paper is certified (e.g., certified by the Forest Stewardship Council (FSC) or Sustainable Forest Initiative (SFI)), and whether the paper is carbon neutral. Based in these characteristics, an intermediate dataset may be generated, wherein the intermediate dataset represents an initial interpretation of the input dataset.

Embodiments of the present invention may rely on an intermediate dataset to calculate one or more environmental savings. The environmental savings could include, but are not limited to, number of trees saved, amount of water saved, amount of energy saved, number of household equivalent power saved, amount of carbon emissions saved, number of automobile equivalent carbon emissions saved, and number of acres saved. According to certain embodiments of the present invention, the environmental savings may be calculated based on a portion of the input dataset, without the use of an intermediate dataset.

Once generated, the environmental savings may be formatting in an XML document for customized display in a web browser or stand alone computer application. The calculated environmental savings may be displayed in comparison with corresponding figures reflective of the possible environmental savings achievable through alternative printing methods.

Embodiments of the present invention provide for a system and method configured to receive an input dataset associated with the printing job, calculate one or more environmental savings based on at least a portion of the input dataset, and generate an output set based on the one or more environmental savings.

### BRIEF DESCRIPTION OF THE DRAWINGS

The present invention will be more readily understood from the detailed description of exemplary embodiments presented below considered in conjunction with the attached drawings, of which:

FIG. 1 depicts an exemplary communications network including an Environmental Savings Calculation System, in accordance with an embodiment of the present invention;

FIG. 2 illustrates an exemplary method for calculating the environmental savings associated with a given printing job, in accordance with an embodiment of the present invention;

FIG. 3 illustrates an exemplary method for calculating an intermediate dataset utilized when calculating an environmental savings, in accordance with an embodiment of the present invention; and

FIG. 4 illustrates an exemplary method for calculating the emissions savings associated with a given printing job, in accordance with an embodiment of the present invention.

### DETAILED DESCRIPTION OF THE INVENTION

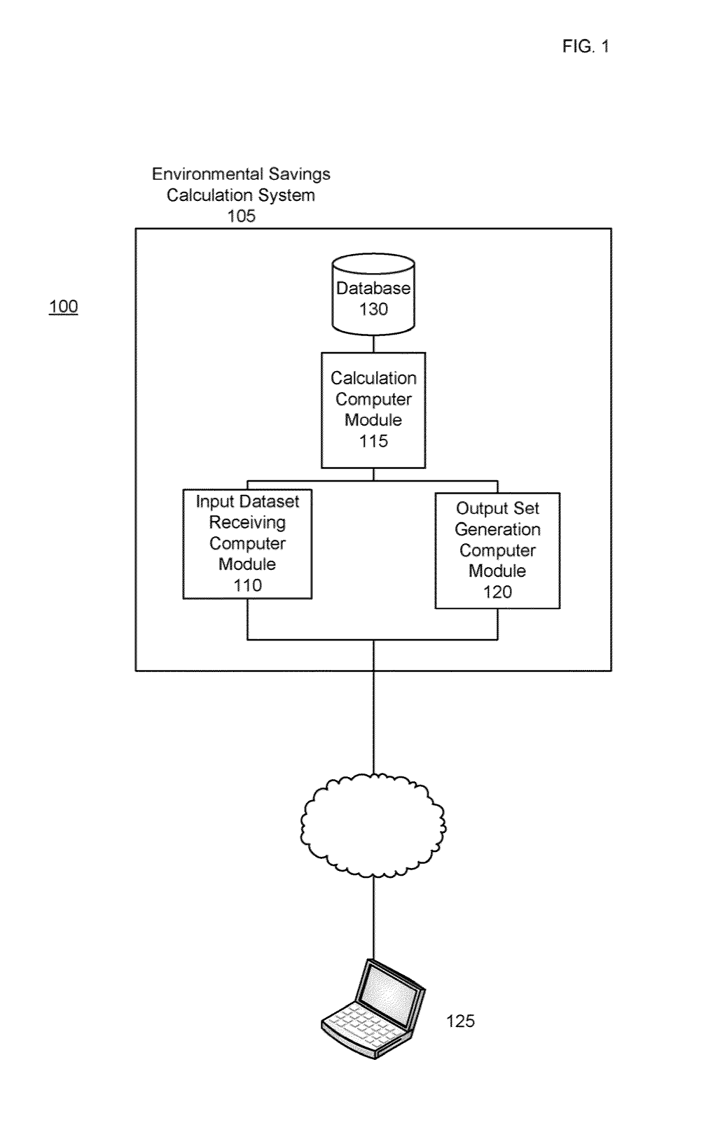

FIG. 1 depicts a data network 100, wherein the data network includes an Environmental Savings Calculation System 105, according to an embodiment of the present invention. The Environmental Savings Calculation System 105 is a computer-based system, accessible by one or more users by way of a Computer Terminal 125 who wish to determine possible environmental savings related to a given printing job or paper purchase (hereinafter a “printing job”).

As illustrated in FIG. 1, the Environmental Savings Calculation System 105 includes, but is not limited to, the following components: an Input Dataset Receiving Computer Module 110, a Calculation Computer Module 115, an Output Set Generation Computer Module 120, and a Database 130. As used herein, the term ‘computer module’ is intended to include, but is not limited to, one or more computers configured to execute one or more software programs configured to perform one or more functions. The term ‘computer’ is intended to include any data processing device, such as a desktop computer, a laptop computer, a mainframe computer, a personal digital assistant, a server, a handheld device, or any other device configured to process data. The aforementioned components of the Environmental Savings Calculation System 105 represent computer-implemented hardware and software modules configured to perform the functions described in detail below. One having ordinary skill in the art will appreciate that the components of the Environmental Savings Calculation System 105 may be implemented on one or more communicatively connected computers. The term ‘communicatively connected’ is intended to include, but is not limited to, any type of connection, whether wired or wireless, in which data may be communicated, including, for example, a connection between devices and/or programs within a single computer or between devices and/or programs on separate computers. Each of the elements within Environmental Savings Calculation System 105 may be communicatively connected to each other.

According to certain embodiments of the present invention, the Environmental Savings Calculation System 105 may be implemented at least as a stand alone computer application, a web based application, or an application executing on a mobile computing device.

As illustrated in FIG. 1, the Environmental Savings Calculation System 105 is communicatively connected to the Computer Terminal 125 via a network (e.g., an intranet connection, the Internet, etc.) For example, the Computer Terminal 125 may be a business or individual interesting in determining the possible environmental savings associated with a printing job.

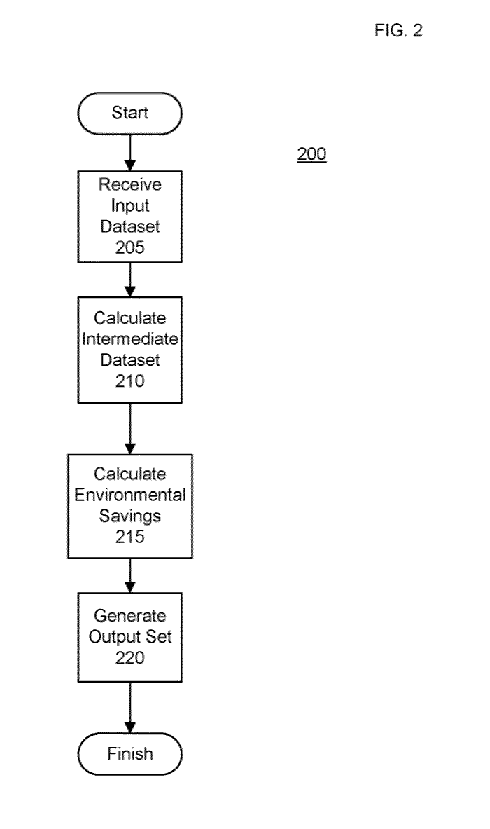

The features and functionality of embodiments of the Environmental Savings Calculation System 105 and its components are described in detail in connection with the system diagram of FIG. 1 and the process flow diagram of FIG. 2.

The method 200, described in FIG. 2, begins with the receipt of an input dataset. The Input Dataset Receiving Computer Module 110 is a computer module configured to receive an input dataset, in step 205 of FIG. 2. As used herein, the term ‘input dataset’ is intended to include, but is not limited to, the parameters that describe a printing job requested by a user. The input dataset could include, but is not limited to, paper height, paper weight, number of papers in each item being printed, number of items being printed, percentage of recycled content in the paper, whether the paper is coated or uncoated, whether the paper is certified (e.g., certified by the Forest Stewardship Council (FSC) or Sustainable Forest Initiative (SFI)), and whether the paper is carbon neutral. In an embodiment of the present invention wherein the Environmental Savings Calculation System 105 is implemented as a web application, the Computer Terminal 125 may transmit the input dataset to the Input Dataset Receiving Computer Module 110 via a wired or wireless communication connection.

For example, a conference organizer may be interested in securing five hundred brochures for distribution to conference attendees. The conference organizer may be interested in assessing the environmental savings available if a vendor employs environmental printing methodologies when creating the brochures. The conference organizer may first provide the Input Dataset Receiving Computer Module 110 with an input dataset. The input dataset provided by the conference organizer may specify that the brochures will be twelve inches tall by five inches wide, including ten pages, and be printed on coated sixty pound FSC certified fifty percent post consumer recycled paper. According to the embodiment of the present invention described in FIGS. 1 and 2, the Input Dataset Receiving Computer Module 110 will receive this input dataset from the conference organizer at step 205, of process 200.

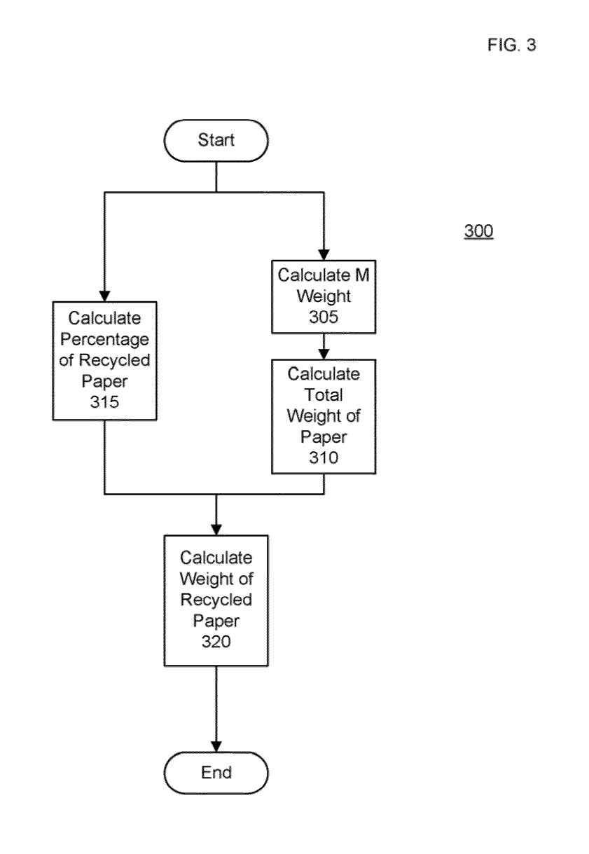

Following the receipt of the input dataset by the Input Dataset Receiving Computer Module 110 at step 205, the input dataset is transmitted to the Calculation Computer Module 115. The Calculation Computer Module 115 uses at least a portion of the input dataset to calculate the intermediate dataset, in step 210 of FIG. 2. The term ‘intermediate dataset’ is intended to include, but is not limited to, a set of data produced by performing one or more calculations on at least a portion of the input dataset. According to certain embodiments of the present invention, the intermediate dataset represents an extrapolation of the input dataset and creates a set of data upon which the environmental savings can be more easily calculated. The method 300, illustrated in FIG. 3, describes the steps performed when calculating the intermediate dataset, according to an embodiment of the present invention.

In reference to FIG. 3, the method 300 begins by calculating the M-Weight associated with the printing job, at step 305. The M-Weight represents the weight of the paper used for the printing job in terms of one thousands sheets. The M-Weight is based on the height and width of the paper selected for the given printing job. Based on these factors, the M-Weight is calculated according to the following equation:

$$M \text{-} Weight = \frac{\begin{matrix}Height of Selected Paper * \\ Width of Selected Paper\end{matrix}}{Basis Height * Basis Width} * 2 * Basis Weight$$

wherein, the Basis Weight represents the weight of one ream (500 sheets) of a given type of paper, and the Basis Height and the Basis Width represent the dimensions for a sheet of paper from the given ream. An example of such dimensions could be 25 inches Basis Width and 38 inches Basis Height. The Basis Weight, Basis Height, and Basis Width may vary based on paper type. Through the use of these inputs, the M-Weight calculated in step 305 will represent the weight of one thousand sheets of the paper being used for a printing job.

Given that the printing job may require more or less paper than 1000 sheets of paper, the M-Weight is used to calculate the total weight of paper required for the printing job, at step 310. First the Base Weight may be calculated by multiplying the M-Weight by the number of pages in the printing job per one thousand sheets, according to the following equation:

$$Base Weight = \frac{Number of Pages in the Printing Job}{1000} * M \text{-} Weight$$

The Base Weight may then be adjusted to account for imperfections in the printing process. For example, the Base Weight may be adjusted to account for spoilage, wherein an entire sheet of paper is lost, or waste, wherein a border of a sheet of paper is cut off after printing. In an embodiment of the present invention wherein spoilage and waste must be accounted for, the following equation may be used to adjust the Base Weight to calculate the total weight:

$$Total Weight = \frac{Base Weight}{( 1 \text{-} Spoil \% ) ( 1 \text{-} Waste \% )}$$

wherein the spoil percent represents the portion of the total weight lost due to spoilage and the waste percent corresponds to the portion of the total weight lost due to waste. The resulting total weight represents the total weight of paper that is utilized during the preparation of a given printing job. The total weight is one piece of data included in the intermediate dataset. In addition to being part of the intermediate dataset, certain embodiments of the present invention may utilize the total weight to determine the weight of recycled paper included in a printing job, at step 320.

In order to determine the weight of recycled paper included in the printing job, at step 320, the percentage of recycled paper included in the requested for the printing job is calculated, at set 315. According to an embodiment of the present invention, the percentage of recycled paper may be calculated by adding the post-consumer waste percentage, associated with the paper, with the post-industrial waste percentage, associated with the print processes utilized during the printing job. The term ‘post-consumer waste’ is intended to include, but is not limited to, the amount of recycled content contained in a specific type of paper. An example of a typical post-consumer waste value may be 10% recycled content. The term ‘post-industrial waste,’ or pre-consumer waste, is intended to include, but is not limited to the amount of paper in a printing job that is recycled during the printing process. The post industrial waste may vary between printing companies depending on their recycling practices. Other factors in addition to, or instead of, post-consumer waste and post-industrial waste may be included when calculating the percentage of recycled paper.

The method 300 concludes by calculating the weight of the recycled paper, at step 320. In calculating the weight of recycled paper used in the printing job, the total weight determined in step 310 is multiplied by the percentage of recycled paper calculated in step 315. The resulting quantity, the recycled weight, reflects the amount of recycled paper utilized in the printing job or created for use by other printing jobs. The recycled weight is one piece of data included in the intermediate dataset.

Returning to the example of the conference organizer planning to acquiring five hundred brochures to distribute to conference attendees, execution of the method 300 may establish that a certain type of paper and printing process utilized by a vendor could result in producing a total weight of one hundred pounds of paper with a recycled weight of twenty five pounds. Based on the calculated total weight and recycled weight, certain embodiments of the present invention may highlight the environmental savings that could be derived during the production of the brochures.

According to the embodiment of the present invention described in FIG. 3, the method 300 describes creating a total weight and a recycled weight, wherein each value may be included in the intermediate dataset. According to alternative embodiments of the present invention, additional values may be calculated and included in the intermediate dataset.

Returning to FIGS. 1 and 2, the method 200 continues following the calculating of the intermediate dataset, at step 210, with the calculation of the environmental savings by the Calculation Computer Module 115, at step 215. In this step, the Calculation Computer Module 115, may calculate one or more environmental savings that could be achieved through the use of environmental printing methodologies. According to certain embodiments of the represent invention, the intermediate dataset may be utilized to calculate one or more of the environmental savings.

Environmental savings can be achieved through the use of environmental friendly paper and environmental printing methodologies. Environmental friendly paper may include, but is not limited to, paper produced with recycled content or manufactured by environmentally low impact paper mills. Environmental printing methodologies may include, but is not limited to, printing techniques utilizing green chemistry principles. These green chemistry principles may included, but are not limited to, prevention of waste, designing safer chemicals, designing less hazardous chemical syntheses, using renewable feedstock, using catalysts, avoiding the use of chemical derivatives, maximizing atom economy, using safer solvents and reaction conditions, increasing energy efficiency, designing chemicals and product to degrade after use, analyzing pollution prevention in real time, reducing the use of volatile organics compounds, and minimizing the potential for accidents.

According to certain embodiments of the present invention, environmental savings could be calculated in terms of the amount of trees, energy, or water saved by using environmental printing methodologies compared to alternative methods. These environmental savings may be based upon the intermediate dataset, more specifically, the recycled weight. In addition, individual savings coefficients may be relied upon for each type of environmental savings. Therefore, a tree coefficient, energy coefficient, and water coefficient may be obtained and coupled with the recycled weight to determine the environmental savings in terms of trees, energy, and water. According to the embodiment of the present invention illustrated in FIG. 1, these coefficients may be stored in the Database 130. In an alternative embodiment, these coefficients may be retrieved electronically or manually from a third party. For example, these coefficients may be retrieved from the Environmental Defense Fund or other organization. In further embodiments of the present invention, the coefficients may be incorporated into the Calculation Computer Module 115.

Following the retrieval of the necessary coefficients, the environmental savings for each category may be calculated. These saving are calculated by multiplying the recycled weight by the given coefficient. For example, when calculating the number of trees saved achieved by using recycled content within a given printing job, the recycled weight is multiplied by the tree coefficient. For example, if the recycled weight is 25 pounds and the tree coefficient is 0.40, then the use of recycled content for a given printing job will produce a savings of 10 trees. The environmental savings in terms of energy and water could be calculated by multiplying the recycled weight by their respective coefficient.

The environmental savings in terms of energy could be further interpreted by dividing the total energy savings by the amount of energy used to power a single household. This would allow the energy savings to be represented in terms of households.

In an alternative embodiment of the present invention, additional categories of environmental savings may be calculated based on additional coefficients. It should be noted that the value of each coefficient may differ as a result of using coated or uncoated paper.

According to certain embodiments of the present invention, acres saved may be an environmental savings calculated by the Calculation Computer Module 115. To calculate acres saved, the paper utilized in the printing job should be assigned a percentage of sustainably forested pounds. Sustainably forested pounds may correspond to the weight of paper pulp from forests certified by a national, international, or forest management organization. A sustainable forest corresponds to land, wherein the land is prepared for new growth after being forested. The percentage of sustainably forested pounds may be assigned by an industry group as a result of certifying a given type of paper. For example, paper certified by the FSC or SFI may be assigned a percentage of sustainably forested pounds. The FSC may assign a quantity as the percentage of sustainably forested pounds, such as 50%, wherein this percentage may vary based on differing sustainable foresting methodologies. Given the percentage of sustainably forested pounds, the acres saved through the use of sustainably forested paper may be calculated by multiplying together, the total weight of paper for the given printing job, tree coefficient, and the percentage of sustainably forested pounds. This product is then divided by the number of trees per acre to generate the acres saved through the use of sustainably forested paper. By way of example, for a given printing job wherein the total weight of paper is 1,000 pounds, the tree coefficient is 0.40, the number of trees per acre is 500, and the percentage of sustainably forested pounds is 50%, then the acres saved will be equal to 0.4 acres.

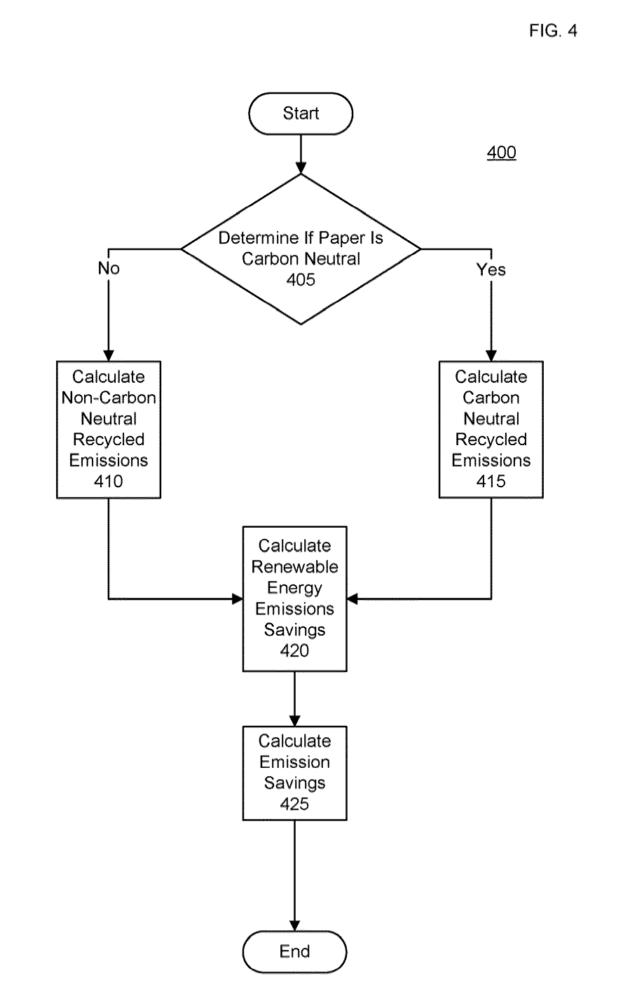

According to certain embodiments of the present invention, the Calculation Computer Module 115 may calculate the emissions saved by using recycled content and other environmental printing methodologies when completing a printing job. FIG. 4 illustrates the method 400 for calculating emissions savings. The method 400 calculates the emissions savings with respect to carbon emissions, however, alternative embodiments of the present invention may calculate the emissions savings in terms of other types of emissions generated when fulfilling a given printing job.

The method 400 described in FIG. 4 begins by determining if the printing job incorporates carbon neutral methodologies. This could include the use of carbon neutral process during the production of paper or while printing on the paper. If it is determined that carbon neutral methodologies are not used, the method 400 continues to step 410, wherein if the carbon neutral methodologies are used, the method 400 continues to step 415.

According to an embodiment of the present invention wherein carbon neutral methodologies are not used during the printing job, step 410 of the method 400 calculates non-carbon neutral recycled emissions savings. As with the calculation of the tree, energy and water savings described above, the recycled emissions savings is calculated by multiplying the recycled weight for the given printing job with an emission coefficient. The emission coefficient may be retrieved from the Database 130 or from a third party. The product of multiplying the recycled weight by the emission coefficient generates the non-carbon neutral recycled emissions savings.

In an embodiment of the present invention wherein carbon neutral methodologies are used when fulfilling a printing job, step 415 of the method 400 calculate carbon neutral recycled emissions savings. As such, the individual effect for each carbon neutral techniques is aggregated to calculate the carbon neutral recycled emissions savings. Given that print processes and carbon neutral methodologies varied between organizations, each organization may have an organizational printing coefficient. The organizational printing coefficient represents a factor reflective of the environmental effect of a specific organization's printing methods. In an instance where an organization has multiple locations, each location may have its own organizational printing coefficient. A portion of the recycled emissions savings as a result of the carbon neutral methodologies for the given organization is calculated by multiplying the total weight of the paper used in the printing job by the organizational printing coefficient.

The portion of the recycled emissions savings resulting from the carbon neutral methodologies is added to the portion of the recycled emissions savings derived from the use of post-industrial waste to generate the carbon neutral recycled emissions savings. The portion of the recycled emissions savings derived from the used on post-industrial waste is calculated by multiplying the total weight of the printing job by the post-industrial waste percentage associated with the print processes, and multiplying the product of this calculation by an emission coefficient. As a result, the carbon neutral recycled emissions savings is the sum of the portion of the recycled emissions savings as a result of the carbon neutral methodologies and the portion of the recycled emissions savings derived from the recycling of post-industrial waste.

Having calculated the non-carbon neutral recycled emissions savings, at step 410, or carbon neutral recycled emissions savings, at step 415, depending on the characteristics of the printing job, the method 400 continues by calculating the renewable energy emissions savings, at step 420. The renewable energy emissions savings represents the amount of emissions that may be saved when renewable energy is used to complete a printing job. Renewable energy sources may include, but are not limited to, wind, solar, tidal, and bio-mass. In an embodiment wherein the total weight for the given printing job is quantified in terms of pounds, the renewable energy emissions saving is calculated by multiplying the total weight for the given printing job by the kilowatts of energy used to create a pound of paper, and multiplying that number by the amount of emissions generated to create each kilowatt-hour of energy through non-renewable means, such as burning fossil fuels. As a result, the renewable energy emissions savings demonstrates the amount of emissions saved by using renewable energy to complete a given printing job. The renewable energy emissions savings can be adjusted to take into account printing jobs wherein only a portion of the printing job is completed through the used of renewable energy.

Following the calculation of the renewable energy emissions savings, at step 420, the total emissions savings is calculated at step 425. The total emissions savings is calculated by summing the recycled emissions savings with the renewable energy emissions savings. As a result the total emissions savings will represent the emissions savings with respect to a given printing job derived from using both recycling methodologies and renewable energy. The emissions savings may be represented in terms pounds (e.g. pounds of carbon dioxide). The total emissions savings can be manipulated to better convey this information to a use. For example, the total emissions savings can be divided by the amount of emissions produced by a single automobile thereby characterizing the total emissions savings in terms of automobile emissions. This type of manipulation may help users better contextualize the total emissions savings.

Returning to FIGS. 1 and 2, the method 200 continues following the calculating of the environmental savings, at step 215, with the generation of an output set by the Output Set Generation Computer Module 215, at step 220. The output set comprises at least a portion of the environmental savings calculated above and provides this information in a usable format. The output set may also include comparisons between the environmental savings associated with a given printing job and corresponding calculations for the same printing job, wherein different methodologies are used.

According to certain embodiments of the present invention, an output set may include a comparison between a first set of calculated environmental savings and one or, more alternative sets of environmental savings. For example, the output set may include the number of trees and amount of energy saved through the use of environmental methodologies by Firm A over a twelve month period. In contrast, the output set could also include the number of trees and amount of energy saved by Firm B over the same twelve month period. In an alternative embodiment of the present invention, an output set could compare the environmental saving of a single firm on month-to-month, year-to-year, or other time period comparison. Further embodiments of the present invention could provide for comparisons between environmental savings for a specific printing job and the environmental saving calculated based on mean data for an organization, or printing jobs at large.

According to certain embodiments of the present invention, the Output Set Generation Computer Module 120 may package the output set as an XML document. This XML document may allow for the output set to be displaying in a web browser or within a standalone application. The following is a sample XML document wherein the output set includes trees saved, water saved, automobile emissions, and acres saved:

<result>

<treesSaved>9.0037</treesSaved>
<waterSaved>3281.3691</waterSaved>
<carEmissions>0.1383</carEmissions>
<acresSaved>0.0244</acresSaved>

</result>.

According to alternative embodiments of the present invention, an XML document representing the output set may be customized to comply with a specific website, software application, or hardware device. The output set may also be represented in a format other than XML, such as a report, spreadsheet, or other electronic or non-electronic formats appreciated by one skilled in the art.

Returning to the example of the conference organizer, after receiving an output set describing the possible environmental savings with respect to one or more printing methodologies, the conference organizer can make a more informed decision regarding the printing job. In addition, vendors conducting business within the printing sector can better quantify the benefits of their environmentally friendly printing techniques when soliciting customers.

In addition to educating consumers of possible environmental savings related to a given printing job, embodiments of the present invention may also be used to minimize adverse environmental impact related to printing jobs. For example, a printing vendor may utilize a calculated environmental savings to dictate waste disposal, energy consumption, paper purchasing, or other paper printing decisions. In terms of paper production, paper manufactures may rely on calculated environmental savings to guide decisions regarding such things as harvesting patterns, renewable energy utilization, or other paper production decisions.

One skilled in the art will appreciate that the present invention can be practiced by other that the described embodiments, which are presented from purposes of illustration and not of limitation, and the present invention is limited only by the claims which follow.

What is claimed is:

1. A computerized method for calculating one or more environmental savings associated with a printing job, comprising:
receiving, by a computer, an input dataset associated with the printing job;
calculating, by the computer, one or more environmental savings based on at least a portion of the input dataset; and
generating, by the computer, an output set based on the one or more environmental savings.

2. The computerized method of claim 1, wherein calculating the one or more environmental savings comprises:
calculating a base weight of the printing job;
calculating a total weight of the printing job based on the base weight; and
calculating a recycled weight of the printing job based on the total weight.

3. The computerized method of claim 1, wherein calculating the one or more environmental savings includes utilizing one or more individual savings coefficients.

4. The computerized method of claim 1, wherein the environmental savings is expressed in terms of a number of trees saved.

5. The computerized method of claim 1, wherein the environmental savings is expressed in terms of an amount of water saved.

6. The computerized method of claim 1, wherein the environmental savings is expressed in terms of an amount of energy saved.

7. The computerized method of claim 1, further comprising, formatting the output set as an XML document.

8. The computerized method of claim 1, further comprising, transmitting the output set for display within a web browser.

9. A environmental savings calculation system comprising:
a input dataset receiving computer module configured to receive an input dataset associated with a printing job;
a calculation computer module configured to calculate one or more environmental savings; and
an output set generation computer module configured to generate an output set based on the one or more environmental savings.

10. The environmental savings calculation system of claim 9, wherein the calculation computer module is configured to:
calculate a base weight of the printing job;
calculate a total weight of the printing job based on the base weight; and
calculate a recycled weight of the printing job based on the total weight.

11. The environmental savings calculation system of claim 9, wherein the calculation computer module utilizes one or more individual savings coefficients when calculating the one or more environmental savings.

12. The environmental savings calculation system of claim 9, wherein the environmental savings is expressed in terms of a number of trees saved.

13. The environmental savings calculation system of claim 9, wherein the environmental savings is expressed in terms of an amount of water saved.

14. The environmental savings calculation system of claim 9, wherein the environmental savings is expressed in terms of an amount of energy saved.

15. The environmental savings calculation system of claim 9, wherein the output set generation computer module is configured to format the output set as an XML document.

16. The environmental savings calculation system of claim 9, wherein the output set generation computer module is configured to transmit the output set for display within a web browser.
